(19) United States
(12) Patent Application Publication
(10) Pub. No.: US 2003/0182968 A1
(43) Pub. Date: Oct. 2, 2003

(54) Apparatus for pulling multibarrel pipettes

(76) Inventor: Zong Yuen Cai, South Plainfield, NJ (US)

Correspondence Address: Zong Yuen Cai, 1207 Hogan Dr., South Plainfield, NJ, 07080, US

(21) Appl. No.: 10/402,008

(22) Filed: Mar. 28, 2003

Related U.S. Application Data
(63) Continuation-in-part of application No. 09/562,440, filed on May 1, 2000, now abandoned.

(51) Int. Cl. C03B 23/045

(52) U.S. Cl. 65/158; 65/286; 65/160

(57) ABSTRACT

The invention is directed to a method of apply controllable pneumatic force in a multibarrel pipette puller to pull single and multibarrel pipettes. A multibarrel pipette puller has a top mechanical portion and a bottom control box. In the top mechanical portion, a metal base is mounted with a pneumatic cylinder, a linear motion guide rail with its movable block connected a clamp body, a pneumatic rotator connected a drill chuck and a pair of heater fixture located between the clamp body and the drill chuck. An optical grid plate is attached on side of the clamp body. An optical sensor is mounted on the metal base along side of the optical grid plate moving path. The piston rod of pneumatic cylinder is connected to the clamp body to deliver pulling and pushing force. The rotator can turn the drill chuck up to 180 degree clockwise or turn counter clockwise back to original position. Both the cylinder and rotator are actuated by pressured air. A single or multibarrel pipette can be clamped one end by the drill chuck and another end by clamp boby. Therefore the clamped pipette can be twisted and pulled by the pneumatic rotator and cylinder. In the bottom control box, there are microcontroller base control board, computerize power supply, precision pressure regulators, air flow controller, pressure sensors, a LCD display and a key pad.

### BACKGROUND OF THE INVENTION

While pipette pullers are well known to pull single to multibarrel pipettes in prior art, two three-jaw chucks are used to hold ends of a multibarrel pipette, a stop plate with a stop adjuster screw stops down ward pulling movement. To change different stop distance on the downward pulling, the stop adjuster screw must be readjusted manually. The two three-jaw chucks requires both ends of a multibarrel pipette to be straight for holding by the three-jaw collect. However, if each barrel is bent to different directions in one end, a multibarrel pipette is much more convenient to connect tubing to each barrel . The pulling method of prior arts is either using magnetic force or gravity force. For using gravity force, many different weight blocks must be used to control and adjust the force level. The force level will not be controlled precisely. For using magnetic force, the bigger force required and the larger size of solenoid coil and magnet will be. There is uneven magnetic force in different positions of a magnet traveling into a solenoid coil. To make a computerize and programmable controlled pipette puller, specifically a multibarrel pipette puller, needs exist to improve the means of pulling and twisting method. Needs exist to improve controllability of pipette clamp movement. Needs exist to improve mechanism of holding a multibarrel pipette with bent barrels in one end. Needs exist to reduce the size and mechanical complication of a pipette puller.

The present invention solves these needs of prior art and try to push a multibarrel pipette puller to a more sophisticate level.

### SUMMARY OF THE INVENTION

The present invention provides controllable pressure air as means of pulling and twisting force for a single and multibarrel pipette puller. The Present invention also provides a multibarrel pipette puller which includes a control box and mechanical portion on the top of the box. The mechanical portion comprises a pneumatic cylinder as the pulling actuator, a pneumatic rotator for twisting a multibarrel pipette, a linear motion guide rail with a movable block horizontally mounted on a metal base, a clamp body with a pair of freely moving clamp blocks in a middle slot for centralize the clamped pipette and an optical grid plate attached on moving direction side of the clamp body for indicating moving distance. The control box comprises a computerize power supply, a microcontroller base control board, precision pressure regulators, air flow controller, pressure sensors, a LCD display, a key pad, LED indicators, power switch and power indicator.

### BRIEF DESCRIPTION OF THE DRAWINGS

FIG. 1 is a perspective view of the multibarrel pipette puller showing a mechanical portion mounted on a control box with a transparent cover.

FIG. 2 is a detail perspective view of the mechanic portion of the multibarrel pipette puller.

FIG. 3 is a detail of the clamp body with two freely moving clamp blocks.

FIG. 4 is a block diagram of the apparatus of this invention for pulling a multibarrel pipette.

### DETAILED DESCRIPTION OF THE DRAWINGS

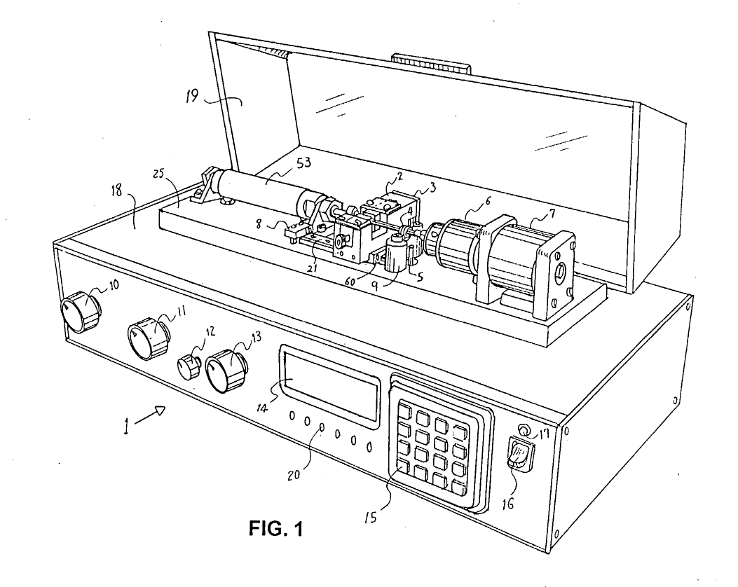

Referring to the FIG. 1, the multibarrel pipette puller is generally indicated by the numeral 1. The pipette puller has a metal base 25 with the mechanical parts mounted on. The mechanical parts include a pneumatic cylinder 53, a linear motion guide rail 21, a movable block 60 of the guide rail, a stopper switch 8 on the end of the guide rail, a clamp body 2 connected to the movable block 60, an optical grid plate 3 attached on side of the clamp body 2, a pair of heater fixture 9 holding a heat coil 4, a pneumatic rotator 7 connected a drill chuck 6. A transparent cover 19 with hinges (can't be seen on the drawing) on the back mounted on top cover of the control box 18 can cover the whole mechanical portion. Within the control box 18, there are electronic parts, sensors, pneumatic regulators, filter and valves inside. A knob 11 on front panel of the control box 18 controls a high range pressure regulator for pulling and twisting force, while a knob 13 controls a low range pressure regulator for pulling force only, and a knob 12 controls an air flow controller for turning (twisting) speed adjustment. A knob 10 controls a pressure regulator for cooling air which will be ejected from tubing 5 toward the heater. The cool air ejecting timing can be programed for rapidly cooling down the heater after heater power turned off. ALCD display window 14 shows the information of the pipette puller programming and operating. LED lights 20 indicate the heater and actuators actions. A keypad 15 lets a user programming and controlling the pipette puller. Power switch 16 turns on or off the pipette puller power which is indicted by a LED light 17.

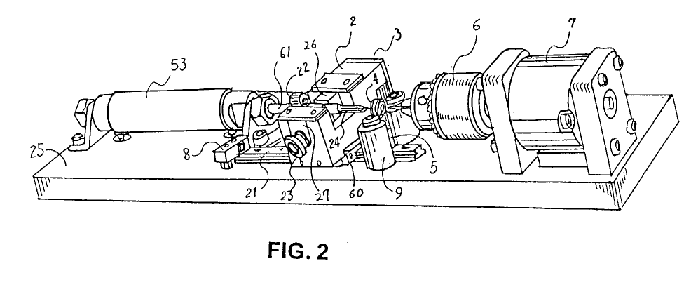

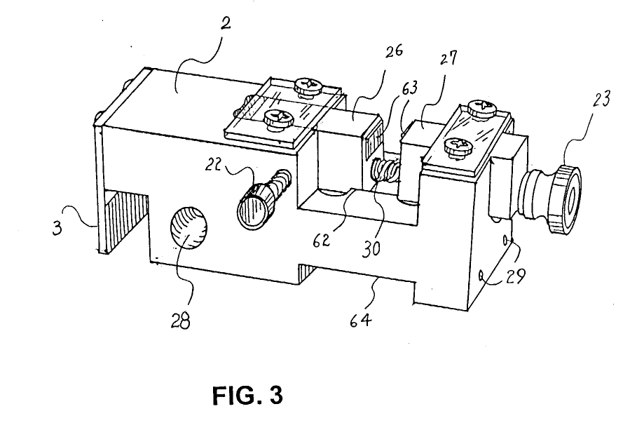

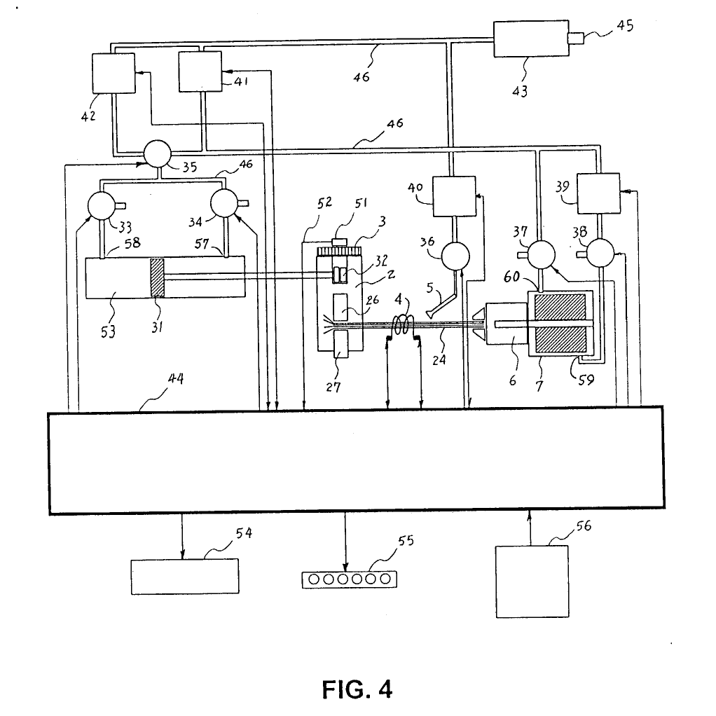

As shown in FIG. 2, a pneumatic cylinder 53 is mounted on the metal base 25. Its piston rod 61 is connected a multibarrel pipette clamp body 2. The clamp body 2 is installed on the moving block 60. The moving block 60 can move freely on the linear motion guide rail 21 with ball bearing. A stopper switch 8 can turn off pulling pressure when the movable block 60 reaches the end of guide rail 21. There are two freely movable clamp blocks 26,27 in the middle of clamp body 2. One end of a multibarrel pipette 24 is clamped by the pair of clamp block 26,27 when a thumb screw 23 is tightened. A thumbscrew 22 can set on the clamp block 26. A pneumatic rotator 7 is connected a drill chuck 6 which can clamp another end of the multipipette 24. When the pressure air is input to one side of the rotator 7, the drill chuck 6 will twist the multipipette. A heat coil 4 is held by a pair of ceramic heater fixture 9. A cool airjet tubing 5 can eject cool air to cool down the heater rapidly after the heater power being off. When the pressure air is input to the pulling side of the cylinder, the clamp body 2 with clamp blocks 26,27 is pulled by the piston rod 61 and is moved away from the heater 4 horizontally along the linear guide rail 21. An optical grid plate 3 is attached one side of the clamp body 2, which is parallel to the moving direction. The drill chuck can be turned clockwise up to 180 degree and then can be turned back counter clockwise to original position. The FIG. 3 shows detail of clamp body 2. A pair of clamp block 26,27 can be moved freely inside the first slot 62. After a pipette being clamped on one end by the drill chuck, the pipette is in the center position. Then the block 26 can be moved to touch another end of the pipette and then can be fixed by a setting thumbscrew 22. The block 27 can be moved toward the block 26 to clamp another end of the pipette by turning the thumb screw 23 clockwise. While turning the thumb screw 23 counter clockwise, a compassion spring 30 can push back the block 27 away from block 26. There are two plastic pads 63 attached on the faces of clamp block 26,27 against each other for holding a single or multibarrel pipette. A hole 28 with a cavity inside can be inserted by the piston rod and the piston rod can be capped by a nut and a cushion 32 (FIG. 4) inside the cavity. On the bottom of clamp body, a second slot 64 being perpendicular to the first slot 62 fits to the movable block 60 (FIG. 2) of linear motion guide rail. A pair of set screw 29 fixes and aligns the clamp body 2 to the movable block 60 (FIG. 2) of linear motion guide rail. An optical grid plate 3 is attached to the side of clamp body. The optical grid plate along side with a optical sensor 51 (FIG. 4) which is fixed on the base 25 (FIG. 2), compose of a optical-digital encoder for movement measuring.

The FIG. 4 shows the multibarrel pipette puller of the present invention in a block diagram form. A microcontroller or a microprocessor base control board 44 combines with pressure sensors and computerize power supply for heater. A LCD 54 displays program and real-time operating information and LED lights 55 indicate actions of pulling, twisting, returning and heating. A key pad 56 sends codes to the control board. A heater coil 4 or foil is supplied with computerize control current from control board and feeds back the change to the sensing circuit of the control board. There is pneumatic cylinder 53 with piston 31. When the 3-way valve 34 is on, pressure air enters pulling input port 57 of the cylinder to pull the clamp body 2 away from the heater, while the 3-way valve 33 is off to let the air out of pushing side of the cylinder 53. When the valve 33 is on, pressure air enters pushing input port 58 of the cylinder to push the clamp body backward to the heater, while the valve 34 is off to let the air out of pulling side of the cylinder. The same control principle is applied to the 3-way valves 37,38, which control the rotator 7 turning clockwise by letting pressure air into input port 59 or counter clockwise by letting pressure air into input port 60. A 3-way valve 35 selects air pressure from high range regulator 41 or low range regulator 42 for the cylinder 53 air supply. Lower pressure air is used for pulling pipette with distance control. Higher pressure air is used for pulling a pipette tip. The regulators are type of manual controlled on the front panel of the control box or type of controlled by microcontroller inside the control box. The air tubing 46 is connected all pneumatic components. Only high range pressure regulator 41 supplies the pressure air to the rotator. But the clockwise turn (pipette twisted direction) is controlled by an air flow regulator 39. A single or multibarrel pipette 24 is clamped by the drill chuck 6 and a pair of clamp blocks 26,27. A pressure regulator 40 controls air pressure to the valve 36. The valve 36 turns on or off the pressure air to the air cool jet tubing 5. The air cool jet tubing is pointed to the heater. The air ejecting timing after the heater being turned off is programmable. An air filter 43 is placed just after the pressure air in put port 45. All heat level, heater on/off timing, pulling timing, pulling distance and actions combination are programmable. A user can press key pad 56 to input his/her programming steps or selects programs which have been set inside the control board 44. All program information and real time heat, pressure and distance measurements are displayed on the LCD 54.

While the present invention has been described in details with reference to the embodiments shown in the drawing, modifications and variations of the invention may be constructed without departing from the scope or spirit of the invention, which is define in the following claims.

I claim:

1. An apparatus for pulling multibarrel pipette or single barrel pipette comprising a pneumatic cylinder mounted on a solid base, a clamp body connected to piston rod of the cylinder, a movable block of a linear motion guide rail connected to said clamp body, the guide rail mounted on said solid base parallel to the cylinder, an optical grid plate attached on moving direction side of said clamp body, a pneumatic rotator mounted on said solid base connected a drill chuck in axial alignment with said linear motion guide rail, said pneumatic cylinder and said linear motion guide rail and said pneumatic rotator mounted horizontally on said solid base, a pair of heater fixtures with a heater mounted on said solid base between said drill chuck and said clamp body, an air cool jet tubing located between two the heater fixtures, an optical sensor mounted on said solid base along side of moving path of said optical grid plate, a hinged transparent cover covered said solid base and all parts on said solid base, said solid base mounted on top of a control box.

2. The apparatus of claim 1, wherein said clamp body comprises a first slot in the middle of said clamp body, and wherein the slot there are two freely movable clamp blocks with a thumbscrew and a spring connected between them, a setting thumbscrew on the slot wall for setting up one of two said movable clamp blocks, a second slot perpendicular to said fist slot located bottom of said clamp body for fitting said movable block of said linear motion guide rail, wherein said second slot wall with two set screws for setting said clamp body to said movable block of said linear motion guide rail, said optical grid plate attached on moving direction side of said clamp body.

3. The apparatus of claim 1, wherein said control box comprises an air filter, high and low range air pressure regulators connected a 3-way valve for selecting pressure supply range to the cylinder, two 3-way valves connected to the cylinder pulling input port and pushing input port separately, an air flow regulator and two 3-way valves connected to the rotator clockwise and counter clockwise input ports separately, a microprocessor or microcontroller base control board with pressure sensors and computerize power supply, a LCD display and a key pad on front panel of said control box for puller information display and programming.

4. The apparatus of claim 1, further comprising means for connecting pneumatic elements, wherein said means having pressure air entering said air filter connected to three pressure regulators with different regulating ranges, two of the regulators connected to one 3-way valve for selected different range pressure, said 3-way valve output connected to other two 3-way valves, which outputs separately connected to pulling input port and pushing input port of the cylinder for pulling and pushing, higher range one of the two regulators also connected to another 3-way valve and said air flow regulator, said 3-way valve output connected to counter clockwise input port of the rotator, said air flow regulator output connected to another 3-way valve and said 3-way valve output connected to clockwise input port of the rotator, third of the regulators connected to an air valve which output connected to said air cool jet tubing for rapid cool down the heater, outputs of said pressure regulators also separately connected to pressure sensors mounted on said control board.

5. An apparatus for pulling multibarrel pipette or single pipette contains:
a. apneumatic rotating means for twisting a multibarrel pipette, said pneumatic rotating means applying pressure air through an air filter, then through a pressure regulator with output pressure measured by a microprocessor base control board with pressure sensors, then through an air flow regulator, then through electronic air valves, driving a pneumatic rotator connected a drill chuck for turning a multibarrel pipette certain degree and returning said drill chuck back to original position after the pipette being pulled and taken out;
b. apneumatic pulling means for pulling a single barrel pipette or a multibarrel pipette, said pneumatic pulling means applying pressure air through said air filter,then through pressure regulators with output pressures measured by said microprocessor base control board with pressure sensors, then through electronic air valves, driving a pneumatic cylinder which piston rod connected to a movable clamp body for pulling a single pipette or a multibarrel pipette and pushing the clamp body back to original position after the pipette being pulled and taken out.
